(19) United States
(12) Patent Application Publication
(10) Pub. No.: US 2007/0162329 A1
(43) Pub. Date: Jul. 12, 2007

(54) Method for offering a search-word advertisement and generating a search result list in response to the search-demand of a searcher and a system thereof

(75) Inventor: Woo Sung Lee, Seoul (KR)

Correspondence Address: BLACKWELL SANDERS PEPER MARTIN LLP, 720 OLIVE STREET, SUITE 2400, ST. LOUIS, MO, 63101, US

(73) Assignee: NHN CORPORATION, Kyunggi-do (KR)

(21) Appl. No.: 10/597,056

(22) PCT Filed: Jan. 27, 2005
(86) PCT No.: PCT/KR05/00222

§ 371 Date: Jul. 10, 2006

(30) Foreign Application Priority Data
Jan. 27, 2004 (KR) 10-2004-0004896

(51) Int. Cl. G07G 1/14

(52) U.S. Cl. 705/14

(57) ABSTRACT

The present invention relates to method and system for providing a search word advertisement which can compute a predetermined expected advertisement cost by predicting the maximum number of expected clicks at the future point with respect to particular search listing, and subtract a cost for execution of advertisement from the expected advertisement cost, wherein the cost for execution of advertisement is determined on the basis of the number of valid clicks that have actually occurred during a contracted advertising period. According to the present invention, in a model for providing an advertisement through a search word advertisement, there is an effect that it is possible to provide method and system for providing a search word advertisement which predict the maximum number of expected clicks by predetermined future point, and adopt a unit cost per click, thereby scientifically computing an expected advertisement cost and charging an advertiser a reasonable advertisement cost.

### TECHNICAL FIELD

The present invention relates to method and system for providing a search word advertisement. More particularly, the present invention relates to method and system for providing a search word advertisement which can compute a predetermined expected advertisement cost by predicting the maximum number of expected clicks at the future point with respect to particular search listing, and subtract a cost for execution of advertisement from the expected advertisement cost, wherein the cost for execution of advertisement is determined on the basis of the number of valid clicks that have actually occurred during a contracted advertising period.

### BACKGROUND OF ART

Today, a search for information through the communication network is being generalized, together with rapid development in the field of communication networks such as the Internet and the like. A user (a searcher) can obtain necessary information easily any time and at any place by using the Internet. In addition, this search for information brings our daily lives a lot of changes.

Therefore, there are developed and suggested variety of models with respect to types of payments of advertisement costs between an operator and an advertiser. At this time, the operator supports search services for Internet users and the advertiser expresses one's own information site through a search, thereby obtaining advertisement effects.

The CPM (Cost Per Thousand) model is an example of a model for paying an advertisement cost and charges an advertiser the same amount of advertisement cost, with respect to the number of clicks that is within a certain range for search results. Namely, an advertisement cost is charged per certain unit (e.g., per thousand) and the advertiser is enabled to pay the charged advertisement cost in advance or later. The advertisement cost of the CPM module is computed through CPI (Cost Per Impression) or a weight adopted method.

However, the CPM model like above does not reflect a change in trend of the number of season-oriented clicks or a change in a sudden increase/sudden decrease of the number of clicks due to special reasons. Therefore, it is true that there is a limit in computing a rational advertisement cost. Especially, there is a problem that in case that the number of impressions increases sharply, an advertiser has no choice but to take the risk for the rise in advertisement costs.

In addition, the CPM model adds an advertisement cost within the contract range for the number of impressions, without regard to a searcher's clicks. Accordingly, there is a problem that it might cause an advertiser to distrust the charged advertisement cost.

As for another example of a model for paying an advertisement cost, there is a widely-used method which determines a unit advertisement cost per click or per impression (a unit click cost or a unit impression cost), measures the total number of clicks or the total number of impressions during an advertising period, and charges the total amount of advertisement costs based on the multiplication of the measured value and the unit advertisement cost.

However, the above conventional advertising methods determine an advertisement cost according to the number of actual impressions and the event of actual clicks at the time when the advertising period ends. Therefore, there is a problem that the advertiser cannot predict the advertisement cost exactly in advance before the advertising period starts. In addition, as a matter of fact, as most advertisers prepare the early budget for advertisement costs, the uncertainty for prediction of advertisement costs is lots of burdens to advertisers.

Accordingly, there is desperately required a new type of model for paying an advertisement cost, in which the advertisement cost is not computed on the same basis, only by search results after the advertising period ends, but predicted in advance before the advertising period starts. Thus, it may be possible to execute and charge the advertisement cost more reasonably. Moreover, there is required a model for charging an advertisement cost which may encourage the advertiser to trust the advertisement cost.

### DISCLOSURE OF THE INVENTION

### Technical Questions

The preset invention is conceived to solve the aforementioned problems. Thus, in a model for providing an advertisement through a search word advertisement, one object of the present invention is to provide method and system for providing a search word advertisement which predict the maximum number of expected clicks by predetermined future point, and adopt a unit cost per click, thereby scientifically computing an expected advertisement cost and charging an advertiser a reasonable advertisement cost.

Furthermore, another object of the present invention is to provide method and system for providing a search word advertisement which adopt regression, thereby determining the maximum number of expected clicks, close to the actual number of valid clicks, wherein the regression computes the number of clicks at the future point on the basis of statistical information on previous clicks.

Furthermore, another object of the present invention is to provide method and system for providing a search word advertisement which subtract an advertisement cost from a reserve fund deposited by an advertiser and even in case that the reserve fund is completely out of, guarantee that an advertisement with respect to search listing will be performed during the contracted advertising period, wherein the advertisement cost is executed based on the actual event of clicks during the contracted advertising period.

Furthermore, another object of the present invention is to provide method and system for providing a search word advertisement which predetermine unit click costs with respect to clicks differently, based on the arranged location of search listing, a season index, and a bid price, thereby computing expected advertisement costs that are optimized for realistic demands.

### TECHNICAL SOLUTIONS

In order to achieve the above objects, a method for generating a search result list in response to a searcher's search request and providing a search word advertisement, comprises the steps of: generating information on the maximum number of expected clicks with respect to a predetermined advertising period, in association with a predetermined search word; generating information on a reserve fund by considering said information on the maximum number of expected clicks and a unit click cost associated with the keyword, thereby transmitting said information on a reserve fund to an advertiser; receiving confirmative information on receipt of money with respect to said information on a reserve fund from an account associated with said advertiser; as the step of maintaining a search information database including search listing associated with said advertiser, in response to receipt of said confirmative information on receipt of money, associating at least one said search listing with the search word; receiving a search request from a searcher; in response to said search request, identifying search listing associated with said search word, thereby arranging said identified search listing; measuring the number of clicks with respect to said arranged search listing; and in correspondence with said measured number of clicks, subtracting said information on a reserve fund.

A system for providing a search word advertisement, comprises of: a search information database for storing a plurality of search listing associated with an advertiser and associating said search listing with a search word; a search engine for abstracting search listing from a database and providing said searcher with at least one abstracted search listing by predetermined arrangement method; a click predicting means for computing information on the maximum number of expected clicks during a predetermined advertising period with respect to said abstracted search listing; a cost computing means for generating information on a reserve fund by considering said computed information on the maximum number of expected clicks and a unit click cost associated with said search word; a settlement control means for transmitting said generated information on a reserve fund to an advertiser associated with said search listing and receiving confirmative information on receipt of money with respect to said information on a reserve fund from an account associated with said advertiser; and an advertisement cost subtracting means for measuring said searcher's number of valid clicks that generate during said advertising period, and subtracting said information on a reserve fund in correspondence with said number of valid clicks; wherein said click predicting means computes the number of expected clicks on the basis of statistical information with respect to the number of clicks during the predetermined previous period and adds up said computed number of expected clicks with respect to said advertising period, thereby generating information on the maximum number of expected clicks.

### BRIEF DESCRIPTION OF THE DRAWINGS

FIG. 1 is a drawing for explaining operations of a system for providing a search word advertisement according to the present invention.

FIG. 2 is a drawing illustrating a system for providing a search word advertisement 200 according to one preferred embodiment of the present invention.

FIG. 3 is a drawing illustrating one example of search listing that is abstracted through a search according to the present invention and an arrangement method thereof.

FIG. 4 is a drawing illustrating one example of computing the maximum number of expected clicks by a click predicting means of the present invention.

FIG. 5 is a flowchart illustrating a method for providing a search word advertisement according to one preferred embodiment of the present invention.

FIGS. 6 and 7 are flowcharts illustrating one example of a method for generating information on the maximum number of expected clicks according to the present invention.

FIGS. 8 and 9 are flowcharts illustrating one example of verification in relation to validity of an account and information on the present state of an advertisement according to the present invention, in which the executed status in relation to an advertisement cost is provided for an advertiser.

FIG. 10 is a flowchart illustrating one example of a method for determining a unit click cost according to another embodiment of the present invention.

FIG. 11 is a flowchart illustrating one example of a method for detecting a valid click with respect to a searcher click according to the present invention.

FIG. 12 is a flowchart illustrating one example of a method for comparing the number of measured clicks with the maximum number of expected clicks, in subtracting a reserve fund according to the present invention.

FIG. 13 is a flowchart illustrating one example of a control method with respect to a free advertising period, in subtracting a reserve fund according to the present invention, wherein the free advertising period changes as the number of actual clicks exceeds the maximum number of expected clicks.

FIG. 14 is a flowchart illustrating one example of a method for providing an advertiser with information on the present state of an advertisement according to the present invention.

FIG. 15 is a drawing illustrating one example of information on the present state of an advertisement in which the present state for clicks per impression is provided, and

FIG. 16 is a drawing illustrating one example of information on the present state of an advertisement for computing ROI (Return On Investment).

FIG. 17 is an internal block diagram of a general-purpose computer which may be adopted in implementing a method for providing a search word advertisement according to the present invention.

### BEST MODE FOR CARRYING OUT THE INVENTION

Hereinafter, method and system for providing a search word advertisement will be described with reference to the accompanying drawings.

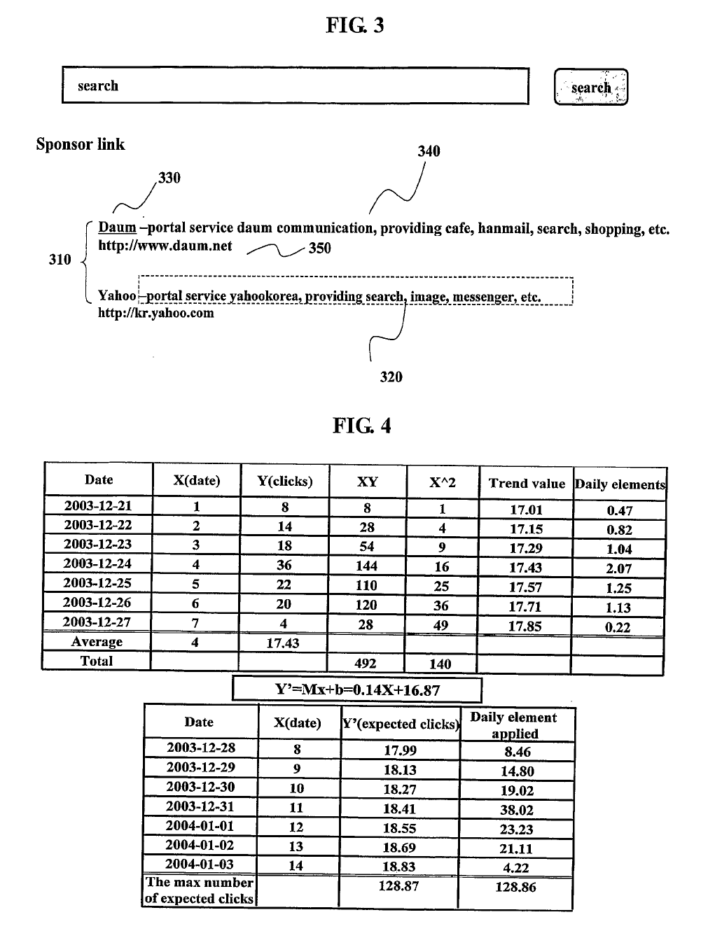

Search listing adopted in the preset specification may mean one item of search results that is abstracted by a search word input into a search engine, thereby being provided for a searcher who has asked for the search. One search listing may include brief information on an information site operated by an advertiser, i.e. a title of contents, an abstract thereof, a network address, and the like. For example, in FIG. 3, one search listing comprises a title of contents, “naver”, a network address, “http://www.naver.com”, and the like. In addition, a search result list is one result abstracted in correspondence to a search word input by a searcher, and implies a list of data provided for a searcher by processing at least one search listing according to a predetermined arrangement order. At this time, the arrangement order is for making orders of abstracted search listing different. Therefore, the arrangement order may be flexibly decided by an operator of each search engine. As for one example, the arrangement order may be determined based on an advertisement cost paid by an advertiser to indicate search listing, accuracy for a search request, popularity, and the registration date.

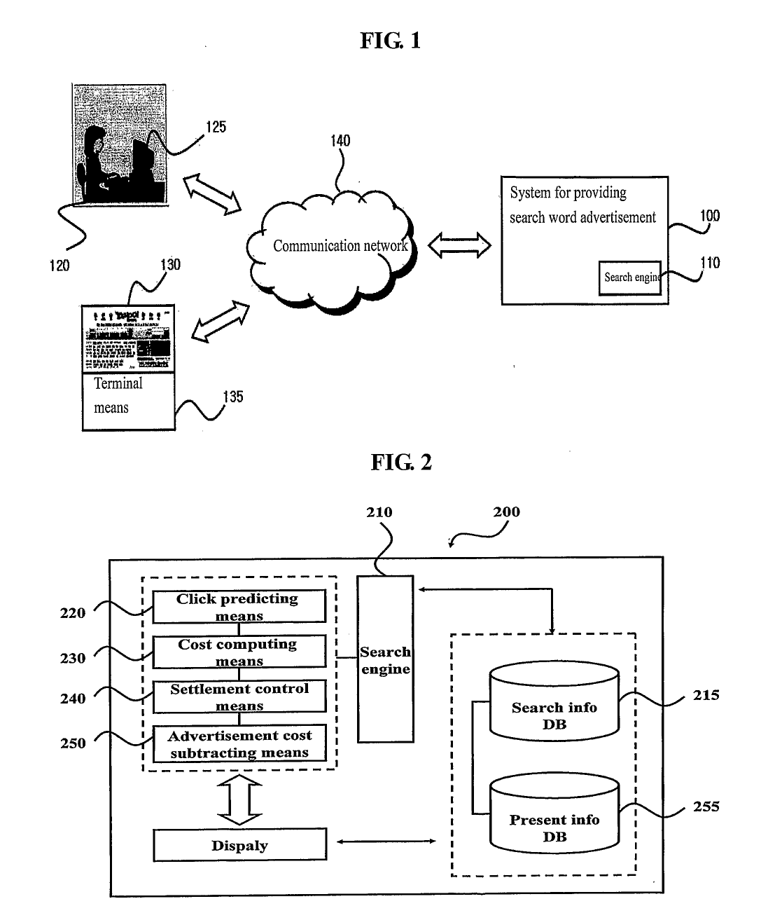

FIG. 1 is a drawing for explaining a network configuration of a system for providing a search word advertisement according to the present invention.

A system for providing a search word advertisement 100 computes the number of input clicks (the number of clicks) of a searcher 120 with respect to search listing, and charges an advertiser 130 of corresponding search listing a certain advertisement cost, based on the computed number of clicks.

First, a search engine 110 means a program or a web server which supports the searcher 120 to get access to the advertiser 130's web site retaining contents that the searcher 120 wants. Namely, in response to a search request of the searcher 120, the search engine 110 enables providing of brief information (preferably, search listing of the present invention) on the advertiser 130 who may provide information that the searcher 120 requests, thereby serving to save time for searching content materials and enhance the accuracy of search materials. Especially, as abstracted brief information (search listing) includes predetermined link information, the search engine 110 may enable the searcher 120 to get access to the particular advertiser 130 in such a manner that the searcher 120 clicks brief information (search listing) displayed on a terminal means 125 of the searcher 120 by using an input tool (e.g., a mouse click). The search engine 110 like above may be divided into a word-oriented searching method, a subject-oriented searching method, and the like. In the present specification, the word-oriented searching method is adopted for a searching method of the search engine 110 to perform the object of the present invention that is to measure the number of clicks with respect to particular search listing abstracted in correspondence to an input search word, thereby computing the advertisement cost of the search listing. However, the fact that the searching method of the search engine 110 is limited to the word-oriented searching method in the present specification is only for convenient explanation and it will be apparent to those skilled in the related art that the present invention is not limited thereto.

The searcher 120 may mean an Internet user who has the terminal means 125 for getting access to the system for providing a search word advertisement 100 according to the present invention and inputs a predetermined search word into the search engine 110, thereby generating a search request for finding the advertiser 130 retaining wanted content materials.

The advertiser 130 means a Contents Provider (CP) who operates an information site of which location is specified on a network by a network address such as for example, an IP address, a URL, a domain, or the like. Thus, the advertiser 130 pays a predetermined advertisement cost to a system operator based on the number of clicks of the searcher 120 for search listing of the information site.

The terminal means 125 and 135 maintain the accessed state with the system for providing a search word advertisement 100 through a communication network 140 such as Internet or the like, and display a search result list comprising at lest one search listing. Examples of the terminal means 125 and 135 include personal computers, handheld computers, PDAs, MP3 players, electronic dictionaries, mobile phones, smart phones and the like, i.e. terminals with a computing function by mounting a predetermined memory means and a predetermined microprocessor. Especially, the terminal means 135 of the advertiser 130 may indicate data in relation to information on the current state of an advertisement for search listing that is under a predetermined contact, for example, the number of impressions, the number of valid clicks, a CTR (Click Through Rate), a UV (Unique Visitor), a ROI (Return On Investment), and the like. This will be in detail described later.

The system for providing a search word advertisement 100 predicts the maximum number of expected clicks during the contracted advertising period, with respect to particular search listing, and in correspondence to the predicted maximum number of expected clicks, generates predetermined information on a reserve fund. At this time, the maximum number of expected clicks is a predetermined statistical value that the number of clicks of the searcher 120 for search listing is predicted, wherein the search listing is abstracted by a search word. Preferably, the maximum number of expected clicks during the advertising period may be predicted in such a manner that the number of daily clicks for future days is respectively computed and added up, wherein the future days are within the advertising period. In addition, information on a reserve fund may be the maximum advertisement cost that may be charged the advertiser 130 within the advertising period, and may be determined by applying a unit click cost or weight to the predicted maximum number of expected clicks. Moreover, the system for providing a search word advertisement 100 may control a cost for execution of advertisement, which is computed based on the number of actual clicks, to be subtracted from information on a reserve fund, thereby adopting a method of computing an advertisement cost per click with respect to search listing. Hereinafter, configuration of a system for providing a search word advertisement 200 according to the present invention will be in detail described with reference to FIG. 2.

The system for providing a search word advertisement 200 comprises a search engine 210, a click predicting means 220, a cost computing means 230, a settlement control means 240, an advertisement cost subtracting means 250, and a present information database 250.

Firstly, the search engine 210 is to locate the aforementioned search engine 110 inside the system for providing a search word advertisement 200. In response to a search request received through an interface unit (not illustrated), the search engine 210 abstracts search listing from a search information database 215 and provides the abstracted search listing for the searcher 120's terminal means 125.

The search information database 215 stores a plurality of search listing related to an advertiser and associates the search listing with a search word. Namely, the search information database 215 stores search listing in which network information in relation to the advertiser 130's information site is standardized into a certain form. For example, the search information database 215 enables abstraction of search listing optimized for the requested searching and quick searching, by classifying/storing search listing according to a predetermined category.

At least one abstracted search listing may be arranged in a differentiated location by the search engine 210, based on a predetermined arrangement method, such as for example, accuracy of search listing, the registration date, popularity (click frequency), a location, an order of paying charges, or the like. A cost per click is different based on the differentiation of arranged locations like above, whereby it is possible to sell search words. In differentiating the cost per click, it is considered that the searcher 120 may click differently particular search listing according to the arranged location. Hereinafter, a search result list generated by the search engine 210 will be in detail described with reference to FIG. 3.

FIG. 3 is a drawing illustrating one example of search listing that is abstracted through a search according to the present invention and an arrangement method.

A search program 300 in FIG. 3 is provided by the search engine 210 of the present invention and may be embodied by the terminal means 125 of the searcher 120. It is assumed that the searcher 120 inputs a search word ‘search’ into the search program 300. At this time, the search engine 210 abstracts a plurality of search listing 320 corresponding to the search word ‘search’ from the search information database 215, and provides the searcher 120 with a search result list 310 arranged as illustrated in FIG. 3. As aforementioned, the arranged location of search listing is determined by a predetermined arrangement method. For example, in FIG. 3, ‘a sponsor link’ may be determined based on an order of paying a certain amount of money to use the location, and ‘a site’ may be determined by the searcher 120's selection for ‘in order of the degree of association, ‘in order of popularity’, ‘in order of registration date’, or the like.

The search listing 320 may further include variety of data such as categories, popularity, and the like, according to functions of the search engine 210 for supporting searching, besides a title of contents 330, an abstract of contents 340, and a network address 340 as aforementioned. Especially, a word included in the tile of contents 330 or the abstract of contents 340, of which meaning is identifiable, becomes an index keyword, i.e. an element for abstracting search listing, thereby enhancing accuracy of searching. For example, it may be determined that it is highly possible that search listing including the input search word ‘search’ in the title of contents 330 or the abstract of contents 340 as an index keyword may retain content materials that the searcher 120 wants. Accordingly, the search engine 210 determines that the search listing is to be abstracted.

The click predicting means 220 computes information on the maximum number of expected clicks during the predetermined advertising period with respect to the abstracted search listing, and predicts the maximum number of expected clicks on the basis of the number of clicks during the predetermined previous period starting from the present time. Information on the maximum number of expected clicks is predictable, for example by regression, and one example of predicting the maximum number of expected clicks will be in detail described with reference to FIG. 4.

FIG. 4 is a drawing illustrating one example of predicting the maximum number of expected clicks by a click predicting means of the present invention.

According to regression, the number of expected clicks (Y′) at the predetermined future time may be determined by regression Y′=b*mˆX or Y′=m·X+b which computes a trend-value. At this time, Y′ may mean the number of expected clicks and X may mean a value in which a date is sequenced. In addition, m and b are variable factors for determining regression, and may be determined satisfying the following formulas:

$$m = \frac{Σ XY - n \overline{X} \overline{Y}}{Σ {X}^{2} - {n ( \overline{X} )}^{2}} and b = \overline{Y} - m \overline{X}$$

(at this time, Y means the number of actual clicks on the date X). In FIG. 4, the maximum number of expected clicks from the future date Dec. 28, 2003 to Jan. 3, 2004 is predicted, based on the present state of clicks with respect to particular search listing from Dec. 21, 2003 to Dec. 27, 2003 (one week). As illustrated in FIG. 4, m and b may be determined based on the number of actual clicks during the previous period, whereby it is possible to induce regression Y′=0.14X+16.87. Therefore, the number of expected daily clicks is predicted by substituting each of future dates (X) for the induced regression, and the maximum number of expected clicks is predicted by adding up each of the number of expected clicks, i.e. ‘128.87≈129’. Namely, the click predicting means 220 predicts the maximum number of expected clicks that may occur during one week in the future, based on the present state of clicks during the previous one week on the present time base. Accordingly, there is an effect that the object of the present invention is faithfully performed to statistically predict the maximum number of expected clicks for the future and pre-charge the advertiser 130 an advertisement cost optimized for the predicted maximum number of expected clicks.

In predicting the maximum number of expected clicks, the present embodiment adopts a method of using regression. However, this is only for convenient explanation. Thus, it will be apparent that the present invention may easily induce that the maximum number of expected clicks is predicted using a time series decomposing method or a casual forecasting method and an advertisement cost is forecasted.

Moreover, as shown in FIG. 4, the click predicting means 220 may compute the number of expected daily clicks more accurately by more applying daily elements to the number of expected clicks predicted by regression. The application of daily elements like above is for reflecting increase or decrease with respect to search listing according to a certain day. Accordingly, besides the daily elements, variable elements such as the number of impressions during a particular period, the present state of season-oriented clicks, and the like may be selectively applied. It is apparent that the application of variable elements like above may be flexibly selected by the inventor of the present invention, considering system environments or change in the number of clicks. For example, in case that it is assumed that particular search listing generates the most number of clicks on Wednesday, daily elements of 24th, previous Wednesday, may be determined as a trend-value (Y′)/the number of clicks (X). The determined daily element ‘2.07’ is applied to ‘18.41’, the number of expected clicks of 31st, the next Wednesday, which enables the number of expected daily clicks (≈38) to be predicted accurately.

In the present embodiment, the period used for the number of previous clicks is limited to one week. However, this is only for convenient explanation and it is apparent that the period cited by the inventor of the present invention may be selected flexibly.

Referring to FIG. 2 again, the cost computing means 230 generates information on a reserve fund by considering information on the computed maximum number of expected clicks and a unit click cost associated with a search word. At this time, the unit click cost means an advertisement cost occurred where there is one input of click of the searcher 120 with respect to particular search listing. For example, a differentiated unit click cost may be allocated according to the aforementioned arranged location of search listing. In addition, information on a reserve fund relates to an expected advertisement cost that may occur during the predetermined advertising period, according to the searcher 120's access by impression of search listing and click thereof. More particularly, the information on a reserve fund may mean an amount of money that has to be deposited to a particular account. Namely, information on a reserve fund is for notifying the advertiser 130 of an expected advertisement cost to be paid to the inventor of the present invention. Accordingly, the system for providing a search word advertisement 200 perform advertising operations (access by impression of search listing and click thereof in correspondence to a particular search word) after confirming that the advertiser 130 has sent the notified reserve fund to the particular account. For example, it is assumed that the maximum number of expected clicks with respect to search listing ‘daum’ that is positioned at ‘sponsor link’ in FIG. 3 is ‘129’ in FIG. 4 and a unit click cost is ‘100 won’ per click. The cost computing means 230 may apply the maximum number of expected clicks×unit click cost as an advertisement cost that may occur during the next one week (from Dec. 28, 2003 to Jan. 3, 2004), and generate information on a reserve fund corresponding to ‘12,900 won’.

Moreover, the cost computing means 230 applies various indexes in determining the unit click cost, such as for example, weight according to increase and decrease of season-oriented clicks, a bid according to the arranged location of search listing, and the like. Thus, the unit click cost is determined more reasonably. Determination of unit click cost by application of various indexes like above is for reflecting that there is sudden increase in the click trend in the particular season, or increase and decrease of clicks is outstanding according to arranged locations. The cost computing means 230 predicts an advertisement cost during the predetermined advertising period more accurately and controls the predicted advertisement cost to be charged the advertiser 130. Accordingly, there is an effect that it is possible to enhance reliability with respect to information on a reserve fund and less offend the advertiser 130 in relation to prepayment of advertisement costs.

The settlement control means 240 transmits the generated information on a reserve fund to the advertiser 130 associated with search listing and receives confirmative information on receipt of money from an account associated with the advertiser 130. That is, the settlement control means 240 serves to confirm receipt of money from the advertiser 130 in association with the notified expected advertisement cost. Moreover, a validity inspection may be performed with respect to an account to which the expected advertisement cost is sent. The validity inspection is for verifying whether a financial transaction of predetermined account that is under control of the advertiser 130 may be performed normally. For example, the validity inspection may verify the validity by transmitting information on a predetermined dummy amount to an account that the inventor of the present invention has provided for the advertiser 130, and receiving number data corresponding to information on a dummy amount from the advertiser 130. Namely, the validity inspection may be a process for determining whether a reserve fund (expected advertisement cost) deposited by the advertiser 130 can be withdrawn through normal financial transactions.

In the present embodiment, an account is limited to a financial account that is under control of the advertiser 130. However, this is only for convenient explanation and it will be apparent to those skilled in the related art that there may be a variety of methods for operating accounts, such as a method of receiving confirmative information on receipt of money by sending an expected advertisement cost to an account designated by the system operator according to the present invention, thereby giving a predetermined mileage corresponding to the expected advertisement cost to a cyber account that is allocated to the advertiser 130.

The advertisement cost subtracting means 250 measures the number of clicks of the searcher 120 during the advertising period contracted with the advertiser 130 and in correspondence to the measured number of clicks, subtracts information on a reserve fund. In addition, the advertisement cost subtracting means 250 serves to select a click that is substantially connected to get access to the advertiser 130's information site and measure the number of valid clicks. Moreover, the advertisement cost subtracting means 250 serves to compute a cost for execution of advertisement based on the number of measured valid clicks. In order to measure the number of valid clicks like above, the advertisement cost subtracting means 250 of the present invention adopts a method of using load time and determining that a request for access to the same information site, occurring within the load time, is an invalid click. At this time, the load time is time when information of an information site is output to the terminal means 125 after the click. That is, in case that the searcher 120 inputs the second click with respect to the same search listing within the load time, after inputting the first click with respect to the search listing, the advertisement cost subtracting means 250 determines that the second click is invalid and does not add that up. Therefore, there is an effect that a reasonable and accurate cost for execution of advertisement may be computed by adding up only the searcher 120's valid click. In addition, the advertisement cost subtracting means 250 serves to compute the actual cost for execution of advertisement on the basis of the number of measured valid clicks and subtract the computed cost for execution of advertisement from an account associated with the advertiser 130 at the predetermined point of time. The predetermined point of time may be flexibly determined by the inventor of the present invention. For example, there is a method of subtracting a cost for execution of advertisement from an account immediately after a valid click occurs, a method of subtracting a cost for execution advertisement from an account in bulk at the time when the contracted advertising period ends.

Moreover, the advertisement cost subtracting means 250 compares a reserve fund that is initially deposited to an account (an expected advertisement cost), with a cost for execution of advertisement that is computed based on valid clicks. At this time, in case that the reserve fund is completely out of before the contracted advertising period ends, the advertisement cost subtracting means 250 notifies the advertiser 130 of information related thereto. Namely, in case that the measured number of clicks exceeds the maximum number of expected clicks, the advertisement cost subtracting means 250 stops subtraction of information on a reserve fund from an account and with respect to the period from when the reserve fund to be subtracted is ‘0’ to when the advertising period ends, and notifies the advertiser 130 that connection to corresponding search listing 320 is performed free of charge. Accordingly, access and connection is continuously guaranteed during the first contracted advertising period, without regard to the number of actual clicks. Thus, there is an effect that it is possible to enhance the advertiser 130's reliability on initially intended advertisement effects. Moreover, with respect to search listing of which the measured number of clicks exceeds the maximum number of expected clicks, the advertisement cost subtracting means 250 enables predetermined weight to be further given to the maximum number of expected clicks when making a contract of the next advertising period. Accordingly, it may be possible to provide an opportunity for minimizing or retrieving the system operator's loss.

On the other hand, in case that the reserve fund subtracted by a cost for execution of advertisement remains even after the contracted advertising period ends, the advertisement cost subtracting means 250 generates refund information and gives the remaining reserve fund back to the advertiser 130. Namely, the advertisement cost subtracting means 250 recognizes that the measured number of clicks is less than the maximum number of expected clicks and there is an prediction error with respect to the maximum number of expected clicks, and refunds an advertisement cost for the different number of clicks to the advertiser 130. This brings the advertiser 130 reliability through transparency in processing the advertisement cost and pays attention to prediction of the maximum number of expected clicks. Therefore, there is an effect that it is possible to predict the accurate maximum number of expected clicks.

A present information database 255 records information on the present state of an advertisement, i.e. statistical data generated by advertising with respect to search listing. The information on the present state of an advertisement may include data with respect to a ROI (Return On Investment), a UV (Unique Visitor), a CTR, the number of valid clicks, the number of impressions associated with search listing during a predetermined advertising period, and the like.

The UV (Unique Visitor) means a user who visits a corresponding web site by click. Depending on web sites, frequently, the number of Unique Visitors who have actually visited the web site per click is more important. For example, in case that a site is required to recruit members such as a banner advertisement site, that several users visit the site by clicking it once brings a bigger advertisement effect than that one user visit the site by clicking it several times. In addition, in case that the web site operates a shopping mall, how many visitors have visited the site newly may be more important as an index of advertisement effects. Thus, UV information like above may be very useful to an advertiser associated with the web site.

Each data included in information on the present state of an advertisement is generated, for example, by the aforementioned advertisement cost subtracting means 250, periodically recorded in the present information database 255, and realized on the advertiser 130's terminal means 135 by control of a display.

Although not illustrated in FIG. 2, the system for providing a search word advertisement 200 according to one preferred embodiment of the present invention may further include a database management module for managing the aforementioned databases 215 and 255. The database management module of the system for providing a search word advertisement 200 according to the present invention may be embodied for the object of the present invention, using RDBMS such as Oracle, Infomix, Sybase, DB2, etc, or OODBMS such as Gemston, Orion, O2, etc.

Hereinafter, operations of the system for providing a search word advertisement 200 according to the present invention will be in detail described.

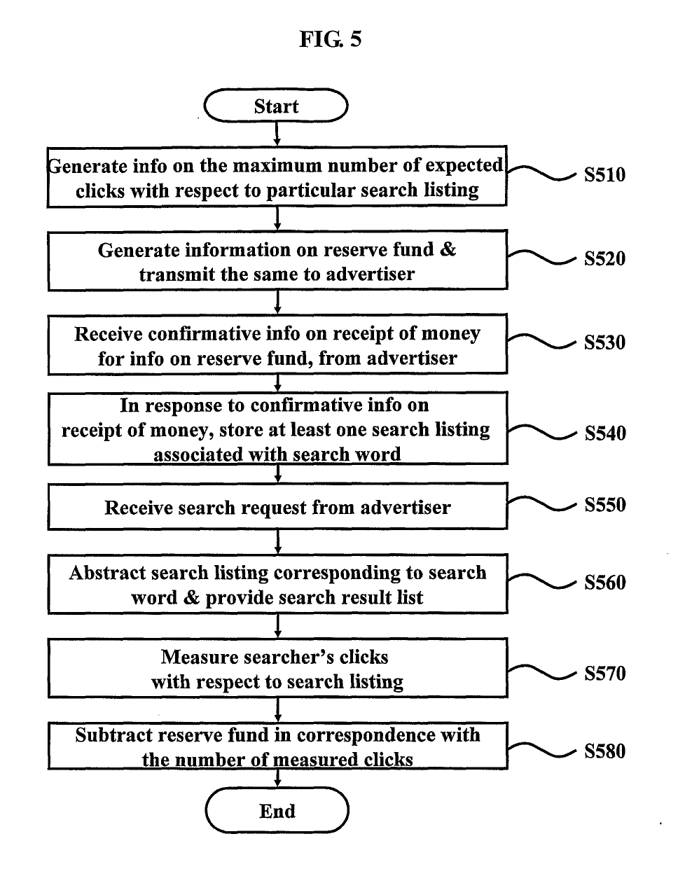

FIG. 5 is a flowchart illustrating a method for providing a search word advertisement according to one preferred embodiment of the present invention.

The method for providing a search word advertisement according to the present embodiment is performed by the system for providing a search word advertisement 200.

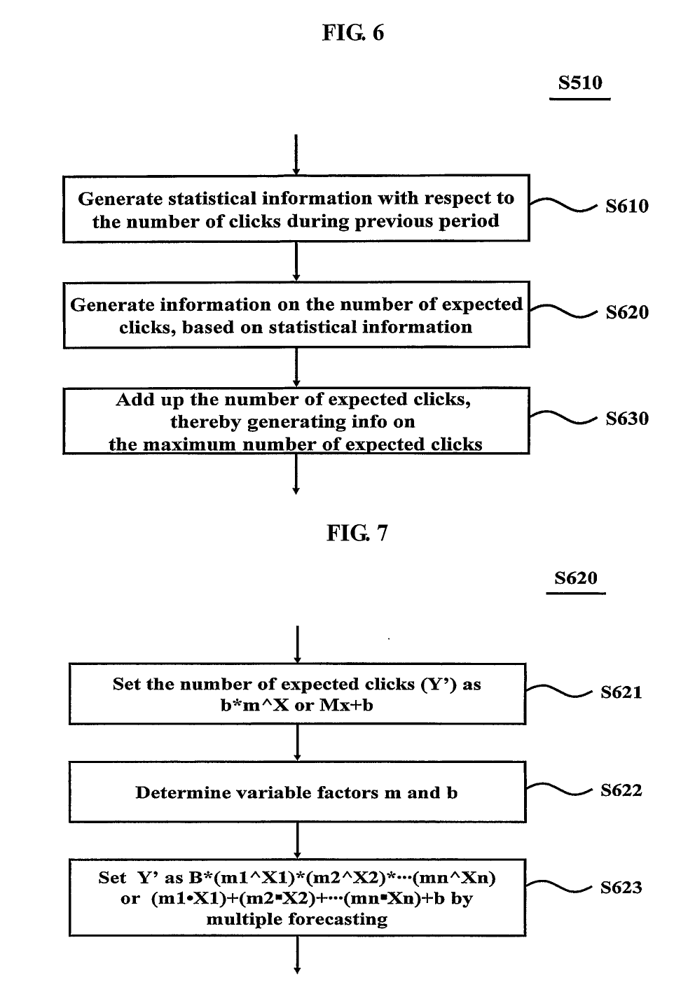

First, the system for providing a search word advertisement 200 generates information on the maximum number of expected clicks with respect to a predetermined advertising period, in association with a search word that is input from the searcher 120 for a search request (S510). This step S510 is a procedure for predicting the number of expected clicks during the future advertising period, with respect to search listing that is controlled to be abstracted by a particular search word. For example, in this step S510, the number of expected daily clicks with respect to the future advertising period may be computed, e.g. by regression, on the basis of information on the number of previous clicks with respect to corresponding search listing, and information on the maximum number of expected clicks may be generated by adding up the number of expected daily clicks (refer to FIG. 4). For example, with respect to search listing abstracted by a particular search word, the number of expected clicks of tomorrow may be computed based on information on the number of clicks that have actually occurred during the past 90 days from today, and the number of expected clicks of the day after tomorrow may be computed based on information on the number of clicks that have actually occurred during the past 89 days from today and the predicted number of expected clicks of tomorrow. The period used as information on the number of previous clicks may be flexibly selected by the inventor of the present invention. Hereinafter, generation of information on the maximum number of expected clicks by regression will be in detail described with reference to FIGS. 6 and 7.

FIGS. 6 and 7 are flowcharts illustrating one example of a method for generating information on the maximum number of expected clicks according to the present invention.

As illustrated in FIG. 6, the system for providing a search word advertisement 200 generates statistical information with respect to the number of clicks during a predetermined previous period (S610). This step S610 is a procedure for determining a period to be used as information on the number of previous clicks in regression. For example, time series data with respect to the number of clicks per day, per week, or per month is obtained. The obtained time series data may be used as data for predicting the number of expected daily, weekly, or monthly clicks during the next advertising period through regression.

In the next, the system for providing a search word advertisement 200 generates information on the number of expected clicks based on statistical information (S620). This step S620 is a procedure for predicting the number of expected daily clicks during the future advertising period, based on the time series data obtained in the step S610. For example, the number of expected daily clicks is predicted using a trend-value. Therefore, the step S620 may further include a method for computing the number of expected daily clicks using the trend-value and the method for computing the number of expected daily clicks will be described with reference to FIG. 7.

The system for providing a search word advertisement 200 sets the number of expected clicks (Y′) by regression as Y′=b*mˆX or Y′=m·X+b (S621). This step S621 is a procedure for setting regression to compute the trend-value. At this time, the trend-value may indicate that long-term and gradual changes of time series are transformed into a numeric value. In the present embodiment, regression is set as Y′=m·X+b, based on FIG. 4.

In the next, the system for providing a search word advertisement 200 determines m and b, variable factors of regression, by using the generated statistical information (S622). This step S622 is a procedure for determining a variable with respect to the set regression. Accordingly, a sequenced value is input in X according to passing of a date included in statistical information, and variable factors m and b are determined, satisfying the following formulas:

$$m = \frac{Σ XY - n \overline{X} \overline{Y}}{Σ {X}^{2} - {n ( \overline{X} )}^{2}} and b = \overline{Y} - m \overline{X}$$

(refer to FIG. 4). It is preferable that n, the number of X, is sufficiently large in determining variable factors m and b. This is for predicting a more accurate trend value in determining the trend value, by depending on more data in relation to the number of previous clicks.

Moreover, in predicting the number of expected clicks by regression according to another embodiment of the present invention, it will be described that variety of variable factors such as the number of impressions during a particular period, the number of season-oriented clicks (season index), and the like are additionally applied.

That the number of impressions or trend in the number of season-oriented clicks is applied to the search listing 320 for computing the number of expected clicks by multiple forecasting. Therefore, the trend-value may be computed by expanding the set regression.

Namely, the system for providing a search word advertisement 200 sets Y′=(b*(m1ˆX1)*(m2ˆX2)* . . . ) or Y′=(m1·X1)+(m2·X2)+ . . . +b, as regression for computing the number of expected clicks (Y′) (S623). This step S623 is a procedure for reflecting information on the number of impressions and information on the number of season-oriented clicks, thereby predicting the number of expected clicks. For example, time series data with respect to the number of impressions of search listing abstracted by a search word, the number of clicks in the same season, or the like may be sequentially input into X1, X2, . . . , Xn.

Referring to FIG. 6 again, the system for providing a search word advertisement 200 adds up the computed number of expected clicks with respect to the contracted advertising period, thereby generating information on the maximum number of expected clicks (S630). This step S630 is a procedure for adding up the number of expected daily clicks within the advertising period, which is computed by regression. For example, the maximum number of expected clicks is predicted by the click predicting means 220.

Accordingly, there is an effect that the object of the preset invention is faithfully performed, wherein the method for providing a search word advertisement according to the present invention predicts the maximum number of expected clicks with respect to search listing that may occur during the predetermined future period, based on statistical information on the number of clicks that have occurred during the predetermined previous period.

Referring to FIG. 5, the system for providing a search word advertisement 200 generates information on a reserve fund by multiplying information on the maximum number of expected clicks and a unit click cost, based on the unit click cost associated with a search word and information on the maximum number of expected clicks (S520), and transmits the generated information on a reserve fund to the advertiser 130. This step S520 is a procedure for computing an expected advertisement cost by applying an advertisement cost to the generated information on the maximum number of expected clicks, wherein the advertisement cost occurs when there is an input of click from the searcher 120 with respect to search listing. The computed expected advertisement cost is transmitted to the advertiser 130 as information on a reserve fund.

At this time, predetermined weight may be further applied to information on a reserve fund transmitted to the advertiser 130, based on statistical information with respect to the number of clicks during the previous period. The weight is determined by considering, such as for example, the latest trend in the number of clicks, a changed numerical value in the number of season-oriented impressions/clicks. Thus, a more reasonable expected advertisement cost is charged. Especially, as the number of clicks having actually occurred becomes larger than the maximum number of expected clicks predicted at the previous advertising period, the system for providing a search word advertisement 200 applies higher weight to the advertiser 130 of search listing 320 which is executed free of charge by statistical information, thereby generating information on a reserve fund more than the previous advertising period. The present embodiment describes that weight is given to the maximum number of expected clicks. However, it will be apparent that it is possible to obtain the same effect with respect to information on a reserve fund by giving predetermined weight to the maximum number of expected clicks or a unit click cost.

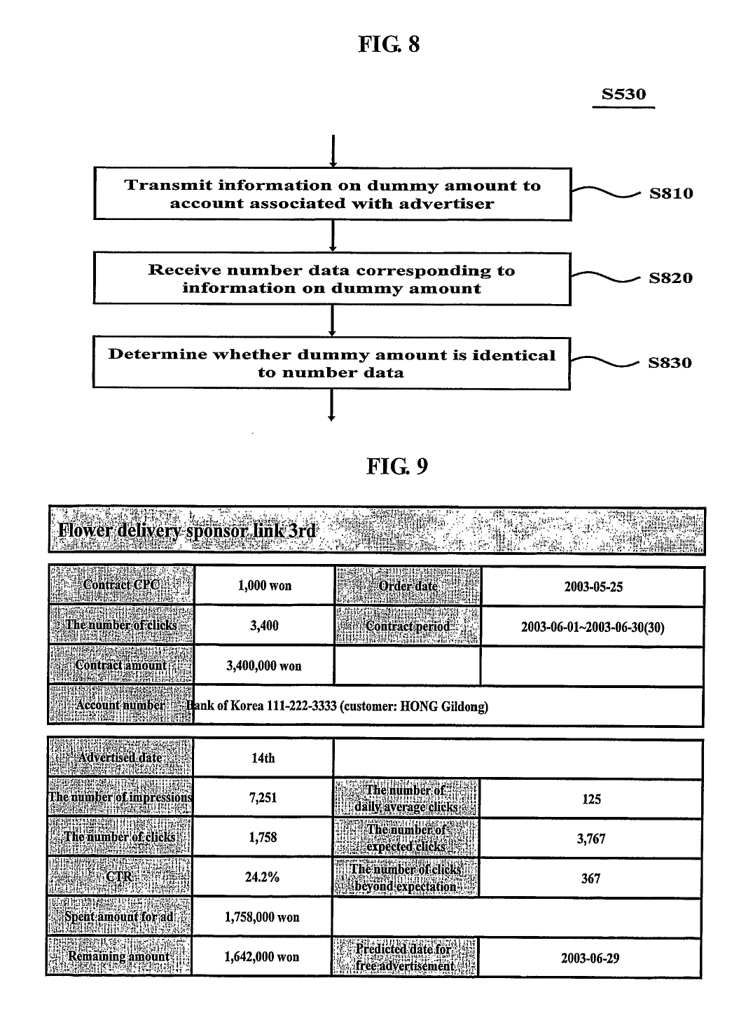

In the next, the system for providing a search word advertisement 200 receives confirmative information on a reserve fund from an account associated with the advertiser 130 (S530). In this step S530, the advertiser 130 who has received information on a reserve fund sends an amount of money corresponding to the information on a reserve fund and receives information related thereto. At this time, the account may be a financial account that is designated by the advertiser 130 or allocated to each advertiser 130 by the system operator according to the present invention. For example, in case that an account is allocated to the advertiser 130, the advertiser 130 sends an amount of money corresponding to information on a reserve fund, to a financial account designated by the inventor of the present invention. In correspondence thereto, data with respect to an expected advertisement cost may be updated (refer to FIG. 9). At this time, the expected advertisement cost is deposited to information on the present state of an advertisement which is provided for the advertiser 130. In addition, in case that the advertiser 130 designates an account for receipt of a reserve fund, the system for providing a search word advertisement 200 verifies validity for the account, thereby determines substantiality for the advertiser 130's financial account from which a reserve fund is subtracted. Hereinafter, verification of validity in relation to an account and information on the present state of an advertisement which is displayed for the advertiser 130, will be in detail described with reference to FIGS. 8 and 9.

FIGS. 8 and 9 are flowcharts illustrating one example of verification in relation to validity of an account and information on the present state of an advertisement according to the present invention, in which the executed status in relation to an advertisement cost is provided for an advertiser.

As illustrated in FIG. 8, the system for providing a search word advertisement 200 first transmits information on a dummy amount to an account associated with the advertiser 130 (S810). This step S810 is a procedure for transmitting information on a small amount of money to a financial account designated by the advertiser 130. For example, a small amount of money less than 1,000 won by unit of 1 won is transmitted to the designated account. This is for determining whether the account designated by the advertiser 130 is capable of making substantial financial transactions under the control of the advertiser 130. Accordingly, in case that information on a dummy amount is transmitted to the account, it is determined that the corresponding financial account is enabled.

In the next, the system for providing a search word advertisement 200 receives number data corresponding to information on a dummy amount from the advertiser 130 (S820). This step S820 is a procedure for receiving number data in relation to the dummy amount input from the advertiser 130 who has confirmed information on the dummy amount sent to the designated account. For example, it is possible to receive particular number data by numbers that the advertiser 130 inputs into a user interface for input of number data, which is provided by the settlement control means 240.

Furthermore, the system for providing a search word advertisement 200 determines whether the dummy amount is identical to number data input from the advertiser 130 (S830). In case that the dummy amount is identical to number data in this step S830, it is determined that validity of the account is verified and it is approved that the corresponding account is used as an account for financial transactions. On the other hand, in case that the dummy amount is not identical to number data or in case that there is no receipt of number data while the predetermined period passes, the validity is rejected. For example, in case that information on a dummy amount sent to an account associated with an advertiser is ‘456’, the system for providing a search word advertisement 200 regards that validity of the account has been verified when number data ‘456’ is received from the advertiser 130.

Accordingly, there is an effect that an illegal financial transaction or making subtraction of a reserve fund impossible is prevented fundamentally by permitting a financial transaction associated with a search word advertisement only with respect to an account of which validity is verified.

When verification of validity with respect to an account is performed like above, information on the present state of an advertisement is provided to the terminal means 135 of the advertiser 130, as illustrated in FIG. 9. The information on the present state of an advertisement includes the aforementioned information on a reserve fund (e.g. contract amount in FIG. 9), the maximum number of expected clicks (the number of contract clicks in FIG. 9), a contracted advertising period, a unit click cost (contract CPC in FIG. 9), account information, and the like. At this time, there is indicated a numerical value determined in the first advertisement contract. In addition, a numerical value that accumulates/changes according to progress of advertising is also updated to be indicated in real time. Therefore, the advertiser 130 is enabled to understand any change in information on the present state of an advertisement fast and easily. For example, as illustrated in FIG. 9, in case that the maximum number of expected clicks during the contracted advertising period (01.06.03˜30.06) is ‘3,400’, and a cost per click is ‘1,000 won’, a contract amount generated as information on a reserve fund may be indicated as ‘3,400,000 won’. Accordingly, there is an effect that the advertiser 130 is enabled to obviously understand condition data of contract with respect to a particular search word or search listing.

Referring to FIG. 5 again, the system for providing a search word advertisement 200 maintains the search information database 215 including search listing associated with the advertiser 130, in response to the received confirmative information on receipt of money (S540). This step S540 is a procedure for storing search listing associated with a particular search word. Therefore, search listing corresponding to a search request input from the searcher 120 is controlled to be abstracted by associating search listing with a search word.

In the next, the system for providing a search word advertisement 200 receives a search request from the searcher 120 (S550). For example, this step S550 is a procedure for receiving an input signal of a search word of the searcher 120 from a search program provided by the search engine 210. Thus, the input search word may be defined as an identifiable word associated with contents materials that the searcher 120 wants.

Furthermore, in response to the search request, the system for providing a search word advertisement 200 identifies search listing associated with the search word from the search information database 215 (S560). This step S560 is a procedure for identifying/abstracting search listing, i.e. search results optimally matched for the input search word and controlling a search result list arranging the abstracted search listing according to a predetermined arrangement criterion to be provided for the searcher 120. As aforementioned, the arranged location of particular search listing may be associated with the size of unit click cost. In addition, a higher unit click cost may be allocated to search listing located in a place where the searcher 120 is enabled to click abstracted search listing easily.

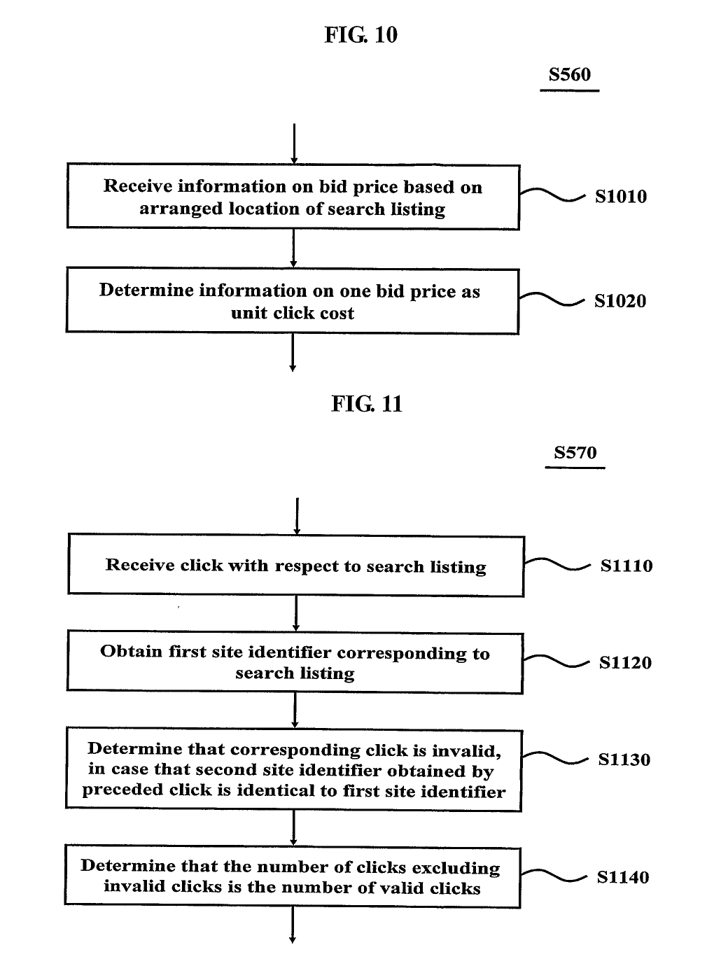

As for another embodiment of the present invention for determining a unit click cost by considering the arranged location of search listing like above, there may be a method for determining a unit click cost in accordance with the arranged location by bid. This will be in detail described with reference to FIG. 10.

FIG. 10 is a flowchart illustrating one example of a method for determining a unit click cost according to another embodiment of the present invention.

First, the system for providing a search word advertisement 200 receives information on a bid price, based on the arranged location of search listing, from at least one advertiser 130 (S1010). This step S1010 is a procedure for receiving information on differentiated bid prices, in accordance with locations of search listing in a search result list, from the advertiser 130. For example, the inventor of the present invention may allocate a certain level of basic bidding amount per particular arranged location, and control information on a bid price received from the advertiser 130 to exceed the assigned basic bidding amount. For example, in FIG. 3, it is possible to differently allocate a basic bidding amount of sponsor link, which is easy to be exposed to the searcher 120, as ‘100 won’ and allocate that of site, which is generally exposed, as ‘50 won’. Accordingly, it is prevented that a unit click cost goes down under a certain level. Thus, there is an effect that it is possible to guarantee the system operator profits by allowing a higher value with respect to the arranged location with better advertisement effects.

In the next, the system for providing a search word advertisement 200, with respect to each arranged location of search listing, accepts information on one bid price satisfying a predetermined criterion among received information on bid prices, as a unit click cost (S1020). This step S1020 is a procedure for determining information on a bid price, satisfying the predetermined criterion, preferably suggesting the highest bid price, as a unit click cost. At this time, there is included a procedure for determining the advertiser who has suggested the accepted unit click cost as a successful bidder. Search listing of the advertiser who has suggested the relevant information on a bid price is arranged in the corresponding location of a unit click cost. The accepted unit click cost is transmitted to the advertiser who is a successful bidder.

Accordingly, the advertiser 130 is enabled to locate search listing in a wanted arranged location, by determining a unit click cost and a location through a bid of the present invention. Thus, there are effects that advertisement effects are maximized and that the inventor of the present invention can expect high benefits by increase in a unit click cost.

Referring to FIG. 5 again, the system for providing a search word advertisement 200 measures the searcher's clicks with respect to arranged search listing (S570). This step S570 is a procedure for measuring the searcher 120's clicks which actually occur during the advertising period contracted with the advertiser 130. Through a click in relation to at least one search listing (each search listing may have a respectively different unit click cost) abstracted by a search word, the number of clicks connecting the searcher 120 to the advertiser 130 is computed. At this time, only the number of valid clicks of the searcher 120 by selection of invalid clicks is computed. For this, the system for providing a search word advertisement 200 according to the present invention provides a method for verifying a valid click. Hereinafter, one example of detecting a valid click will be described with reference to FIG. 11.

FIG. 11 is a flowchart illustrating one example of a method for detecting a valid click with a searcher click according to the present invention.

In the present embodiment, the method for determining a valid click sorts out an invalid click using load time, thereby determining a valid click.

First, the system for providing a search word advertisement 200 receives a click for search listing from the searcher 120 (S1110). Namely, a sign of click generated by the searcher 120 is received from at least one search listing abstracted by a search word whereby there is disclosed load time with respect to particular search listing. The load time means the time when the searcher 120 is connected to the advertiser 130 by link information included in search listing, i.e. the delayed time when contents materials retained by the advertiser 130 are displayed on the searcher 120's terminal means 125.

In the next, the system for providing a search word advertisement 200 obtains a first site identifier corresponding to clicked search listing (S1120). This step S1120 is a procedure for recognizing the first site identifier of search listing clicked by the searcher 120, i.e. recognizing network information to get access to the advertiser 130. The system for providing a search word advertisement 200 controls the searcher 120 to be accessed the advertiser 130, based on the recognized network information. At this time, the load time continuously passes after the click.

Furthermore, in case that the obtained first site identifier is identical to a second site identifier, being loaded by the preceded click, the system for providing a search word advertisement 200 determines that a click related to the first site identifier is invalid (S1130). This step S1130 is a procedure for determining a later click as an invalid one, in case that the second site identifier obtained by input of the preceded click is identical to the first site identifier obtained by input of a click having occurred within the load time started by input of the preceded click. That is, with respect to the same site identifier, a plurality of clicks having occurred within the load time is regarded as one click.

After identification with respect to an invalid click, the system for providing a search word advertisement 200 determines the number of clicks except clicks determined to be invalid, as the number of valid clicks (S1140). This step S1140, for example, is a procedure for excluding an invalid click from the number of measured clicks, under the assumption that the number of clicks is measured every time the searcher 120 inputs a click. This step S1140 for determining the number of valid clicks like above is controlled to be performed per predetermined cycle during the contracted advertising period. Accordingly, updating for the number of measured clicks is also periodically performed, thereby enabling the number of valid clicks to be measured more accurately. In addition, in case that a request for termination of advertisement is received from the advertiser 130 within the predetermined advertising period, the step S1140 may be controlled to be performed just before the determination of advertisement with respect to corresponding search listing.

Accordingly, an advertisement cost is charged only with respect to a click occurring substantial connection with the advertiser 130 by revising the number of clicks periodically, and computed more reasonably. In addition, the reliable maximum number of expected clicks with respect to the next advertising period is predicted by measuring the accurate number of clicks.

Referring to FIG. 5 again, the system for providing a search word advertisement 200 subtracts information on a reserve fund sent to an account, in correspondence to the number of measured clicks (S580). This step S580 is a procedure for subtracting a cost for execution of an advertisement based on the searcher 120's clicks with respect to particular search listing, which will be described with reference to FIG. 9. In FIG. 9, information on the present state of an advertisement shows updated information with respect to search listing ‘flower delivery’, at the point of June 14, 14th day after the advertisement is disclosed. At this time, ‘the number of impressions’ may mean how many times search listing is arranged on a search result list by the search word, “flower deliver” and provided for the searcher 120. ‘The number of clicks’ may mean how many times the searcher 120's input of clicks substantially occurred with respect to each search listing. ‘CTR (Click Through Rate)’ indicates ‘the number of impressions’ to ‘the number of clicks’ by percentage. Thus, the ‘CTR’ may be used as data for estimating accuracy or popularity with respect to corresponding search listing. The system for providing a search word advertisement 200 may compute information on a cost for execution of an advertisement (a subtracted advertisement cost as a click actually occurs) and information on a remaining cost of a reserve fund from which the cost for execution of an advertisement is subtracted. Moreover, the system for providing a search word advertisement 200 may understand the trend of the searcher 120's clicks with respect to search listing ‘flower deliver’, thereby further generating information on ‘the number of expected clicks’ or ‘the number of clicks beyond expectation’ at the point of time when the advertising period ends. ‘The number of expected clicks’ or ‘the number of clicks beyond expectation’ like above is very important data in determining reliability for the maximum number of expected clicks predicted with respect to corresponding search listing. In addition, ‘the number of expected clicks’ or ‘the number of clicks beyond expectation’ may be used as important data in performing a free advertisement within a remaining advertising period, or, refunding an unexecuted reserve fund after the advertising period ends.

Hereinafter, as for another embodiment of the present invention, there will be described a variety of methods for providing a search word advertisement which may be come out by subtracting a reserve fund based on the number of valid clicks.

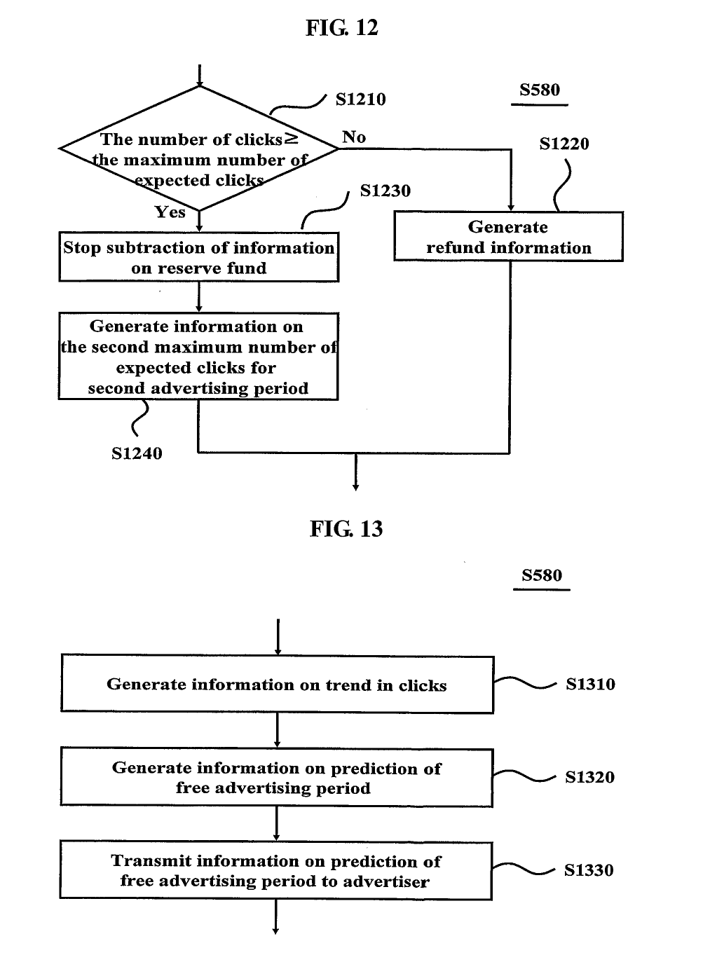

FIG. 12 is a flowchart illustrating one example of a method for comparing the number of measured clicks with the maximum number of expected clicks, in subtracting a reserve fund according to the present invention.

First, the system for providing a search word advertisement 200 compares the number of measured clicks with the maximum number of expected clicks (S1210). This step S1210 is a procedure for comparing and determining how close the number of clicks having actually occurred (preferably, the number of valid clicks) is to the predicted maximum number of expected clicks in making a contract for the advertising period.

As a result in the step S1210, in case that the number of measured clicks is less than the maximum number of expected clicks (No direction, in S1210), the system for providing a search word advertisement 200 generates refund information and transmits the same to the advertiser 130 (S1220). This step S1220 is a procedure for refunding a remaining reserve fund, in case that the number of valid clicks does not reach the predicted number of expected clicks after the contracted advertising period ends. With respect to refunding, there may be considered a varied of methods, such as for example, a method for transferring/transmitting a remaining reserve fund to an account designated by the advertiser 130, a method for controlling a remaining reserve fund to be kept in a predetermined memory means (not illustrated) allocated to the advertiser 130 to be used in making a contract for the next advertising period.

On the other hand, in case that the number of measured clicks exceeds the maximum number of expected clicks as a result in the step S1210 (Yes direction, in S1210), the system for providing a search word advertisement 200 stops subtraction of information on a reserve fund (S1230). This step S1230 is a procedure for controlling a deposited reserve fund to be completely out of as a cost for execution of an advertisement, thereby controlling subtraction of a reserve fund to be stopped when the number of valid clicks during the contracted advertising period exceeds the predicted maximum number of expected clicks. The system for providing a search word advertisement 200 does not additionally charge an advertisement cost corresponding to the period from stopping of subtraction of a reserve fund to termination of the contracted advertising period. That is, in relation to advertising after subtraction of information on a reserve fund is stopped, it is to be converted into a free advertisement automatically. Thus, a service for the advertiser 130 is enhanced and any error in predicting the maximum number of expected clicks does not occur to the advertiser 130. Through guarantee of the advertising period like above, the advertiser 130 may have trust on the inventor of the present invention.

Moreover, the system for providing a search word advertisement 200 generates information on the second maximum number of expected clicks with respect to a second advertising period (S1240). The aforementioned explanations will be applied to generation of information on the second maximum number of expected clicks. This step S1240 is a procedure for revising upwards the second maximum number of expected clicks which is predicted in case that the number of measured clicks during the currently contracted advertising period exceeds the maximum number of expected clicks, i.e. in case that a contract for the next advertising period is under way with respect to search listing for which a free advertisement is performed. For revising upward like above, the present embodiment further applies predetermined weight to the maximum number of expected clicks predicted by the aforementioned regression and enables the higher maximum number of expected clicks to be predicted. Accordingly, the present invention enables the maximum number of expected clicks, closer to the number of clicks that may occurring during the next advertising period, to be predicted. Thus, there is an effect that it is possible to minimize the business loss by free advertising.

FIG. 13 is a flowchart illustrating one example of a control method with respect to a free advertising period, in subtracting a reserve fund according to the present invention, wherein the free advertising period changes as the number of valid clicks exceeds the maximum number of expected clicks.

First, the system for providing a search word advertisement 200 generates information on the trend of clicks based on the number of measured clicks during the predetermined advertising period (S1310). This step S1310 is a procedure for accepting propensity to the number of clicks during a predetermined period, preferably the latest predetermined period close to the present time from the entire advertising period, as information on the trend of clicks. Generation of ‘the number of daily average clicks’ in FIG. 9 may be an example. That is, ‘the number of daily average clicks’ is a numerical value obtained by averaging the total number of clicks during the advertising 14 days. Accordingly, the system for providing a search word advertisement 200 may assume that the number of daily clicks during the remaining advertising period will be maintained to be ‘125’, i.e. ‘the number of daily average clicks’.

In the next, the system for providing a search word advertisement 200 generates information on prediction of the free advertising period, based on information on the trend of clicks (S1320). This step S1320 is a procedure for predicting a period of providing a free advertisement in accordance with propensity to the number of clicks, after a reserve fund is out of by cost for execution of an advertisement. Especially, in case that a reserve fund subtracted by cost for execution of an advertisement is less than a predetermined value, information on prediction of the free advertising period is generated. At this time, the predetermined value may be flexibly determined by the inventor of the present invention, and may be determined, for example, based on that the remaining reserve fund goes down less than 10% of the first deposited reserve fund. For example, in FIG. 9, information on prediction of the free advertising period may become ‘the predicted day for free’. The system for providing a search word advertisement 200 may determine ‘the predicted day for free’ as ‘June 29’, under the assumption that ‘the number of daily average clicks’, ‘125’, is maintained.

In the next, the system for providing a search word advertisement 200 transmits information on prediction of the free advertising period to the advertiser 130 (S1330). This step S1330 is a procedure for notifying the advertiser 130 of the generated information on prediction of the free advertising period. At this time, the event of free advertising is transmitted to the advertiser 130 through an e-mail, a short message, etc. associated therewith 130. For example, ‘the predicted day for free’ may be included in information on the present state of advertisement provided for the advertiser 130's terminal means 135 in real time, and transmitted to the advertiser 130 thereby.

That is, the fact that the free advertising service is being served due to exhaustion of a reserve fund is transmitted to the advertiser 130. Accordingly, there is an effect that the advertiser 130's trust to the present search word advertisement may be enhanced.

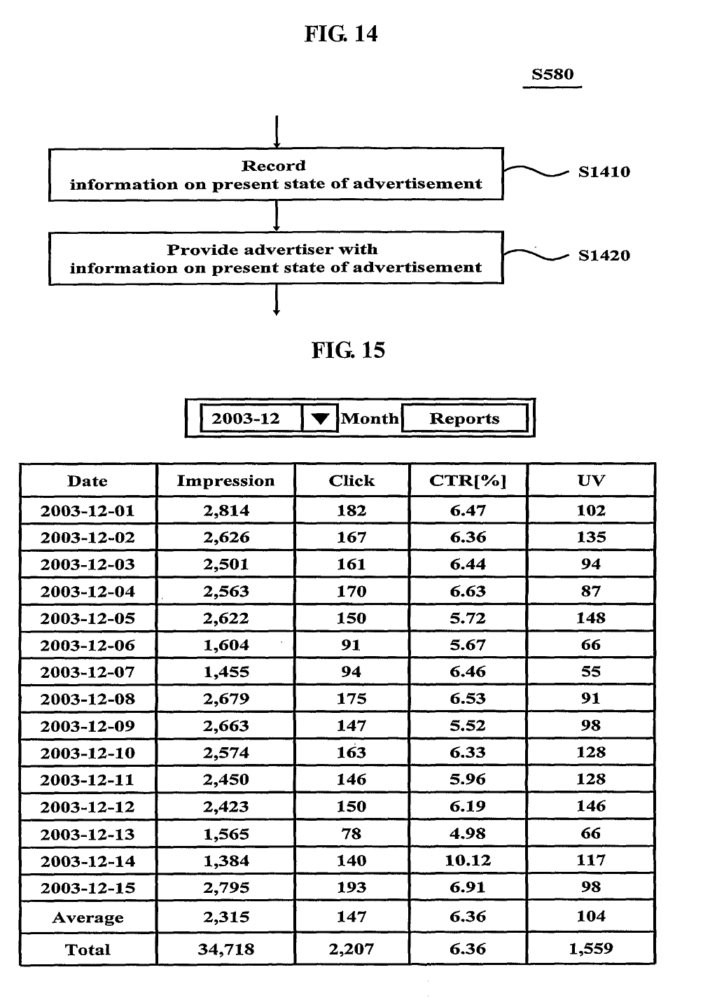

Hereinafter, as for another embodiment of the present invention, information on the present state of an advertisement, showing each numerical value by advertising associated with a search word, will be described with reference to FIGS. 14 to 16.

FIG. 14 is a flowchart illustrating one example of a method for providing an advertiser with information on the present state of an advertisement according to the present invention.

First, the system for providing a search word advertisement 200 maintains the present information database 255 for recording information on the present state of an advertisement associated with a predetermined cost for execution of an advertisement (S1410). At this time, the cost for execution of an advertisement subtracts information on a reserve fund. This step S1410 is a procedure for storing statistical data as information on the present state of an advertisement, wherein the statistical data may be variously generated by the searcher 120's clicks with respect to exposed search listing. At this time, the information on the present state of an advertisement may include data in relation to a CTR, a UV, a ROI, the number of clicks (including the number of valid clicks), the number of impressions associated with the search listing during the predetermined advertising period, and the like.

In the next, the system for providing a search word advertisement 200 provides the advertiser 130 with information on the present state of an advertisement (S1420). This step S1420 is a procedure for providing the advertiser 130's terminal means 135 with a numerical value which changes in real time per input of the searcher 120's click. This will be described with reference to FIGS. 9, 15, and 16.

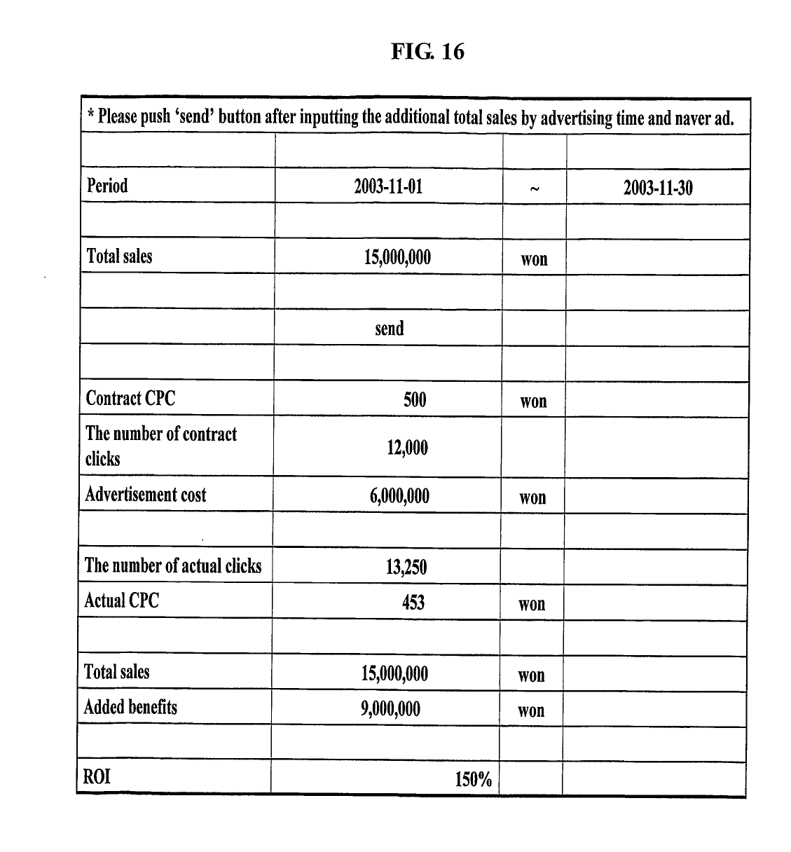

FIG. 15 is a drawing illustrating one example of information on the present state of an advertisement in which the present state with respect to clicks per impression is provided, and FIG. 16 is a drawing illustrating one example of information on the present state of an advertisement for computing a ROI (Return On Investment).

In FIG. 15, there is arranged and recorded statistical information with respect to the number of impressions, the number of clicks, a CTR, and a UV, corresponding to the first half of December in 2003, with respect to particular search listing. Therefore, the advertiser 130 provided with data like above may use the data as reference data for a new contract of the next advertising period, by referring to statistical information and CTR information with respect to particular search listing.

In the meantime, FIG. 16 illustrates a ROI calculator for determining to what extent the amount invested as an expected advertisement cost has contributed to sales. Namely, as the total sales associated with search listing during the particular advertising period and the corresponding period is input, the total amount of advertisement costs of the advertiser 130 is abstracted, for example, from a user database (not illustrated) and provided as information on the present state of an advertisement. Accordingly, the ROI calculator may compute the ROI, ‘150%’ by a proportion expression for the total amount of advertisement costs and the total sales. Thus, there is an effect that the advertiser 130 may build an effective advertisement strategy with respect to a search word advertisement, based on the computed ROI.

The embodiments of the present invention include computer readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). The media may also be a transmission medium such as optical or metallic lines, wave guides, etc. including a carrier wave transmitting signals specifying the program instructions, data structures, etc. Examples of program instructions include both machine code, such as produced by a compiler, and files containing higher level code that may be executed by the computer using an interpreter.

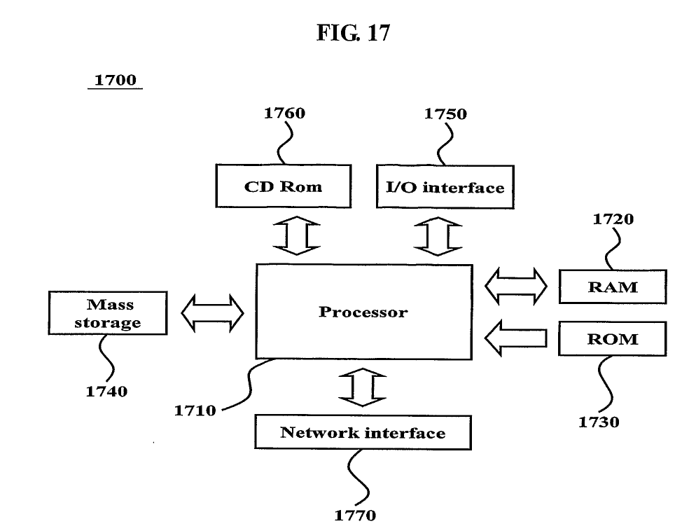

FIG. 17 is an internal block diagram of a general-purpose computer which can be more adopted in implementing the method for providing a search word advertisement according to the present invention.

The computer system 1700 includes any number of processors 1710 (also referred to as central processing units, or CPUs) that are coupled to storage devices including primary storage (typically a random access memory, or “RAM 1720”), primary storage (typically a read only memory, or “ROM 1730”). As is well known in the art, ROM 1730 acts to transfer data and instructions uni-directionally to the CPU and RAM 1720 is used typically to transfer data and instructions in a bi-directional manner. Both of these primary storage devices may include any suitable type of the computer-readable media described above. A mass storage device 1740 is also coupled bi-directionally to CPU and provides additional data storage capacity and may include any of the computer-readable media described above. The mass storage device 1740 may be used to store programs, data and the like and is typically a secondary storage medium such as a hard disk that is slower than primary storage. A specific mass storage device such as a CD-ROM 1760 may also pass data uni-directionally to the CPU. Processor 1710 is also coupled to an interface 1750 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, processor 1710 optionally may be coupled to a computer or telecommunications network using a network connection as shown generally at a network interface 1770. With such a network connection, it is contemplated that the CPU might receive information from the network, or might output information to the network in the course of performing the above-described method steps. The above-described devices and materials will be familiar to those of skill in the computer hardware and software arts.

The hardware elements above may be configured to act as one or more software modules for implementing the operations of this invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching.

Therefore, it is intended that the scope of the invention be defined by the claims appended thereto and their equivalents.

Although the present invention has been described in connection with the embodiment of the present invention illustrated in the accompanying drawings, it is not limited thereto since it will be apparent to those skilled in the art that various substitutions, modifications and changes may be made thereto without departing from the scope and spirit of the invention.

### INDUSTRIAL APPLICABILITY

As aforementioned, in a model for providing an advertisement through a search word advertisement, the present invention provides method and system for providing a search word advertisement which predict the maximum number of expected clicks by predetermined future point, and adopt a unit cost per click, thereby scientifically computing an expected advertisement cost and charging an advertiser a reasonable advertisement cost.

Furthermore, the present invention provides method and system for providing a search word advertisement which adopt regression, thereby determining the maximum number of expected clicks, close to the actual number of valid clicks, wherein the regression computes the number of clicks at the future point on the basis of statistical information on previous clicks.

Furthermore, the present invention provides method and system for providing a search word advertisement which subtract an advertisement cost from a reserve fund deposited by an advertiser and even in case that the reserve fund is completely out of, guarantee that an advertisement with respect to search listing will be performed during the contracted advertising period, wherein the advertisement cost is executed based on the actual event of clicks during the contracted advertising period.

Furthermore, the present invention provides method and system for providing a search word advertisement which predetermine unit click costs with respect to clicks differently, based on the arranged location of search listing, the season point, and the bid price, thereby computing expected advertisement costs that are optimized for realistic demands.

Furthermore, according to the present invention, it is possible to charge an advertiser a more reasonable advertisement cost, by excluding the number of invalid clicks through a procedure for measuring the number of valid clicks.

1. A method for generating a search result list in response to a searcher's search request and providing a search word advertisement, the method comprising the steps of:
generating information on the maximum number of expected clicks for a predetermined advertising period, in association with a predetermined search word;
generating information on a reserve fund using said information on the maximum number of expected clicks and a unit click cost, associated with said search word, thereby providing said information on the reserve fund to an advertiser;
receiving confirmative information on receipt of payment for advertisement based upon said information on the reserve fund from said advertiser;
maintaining a search information database including a search listing associated with said advertiser, in response to receipt of said confirmative information, said search listing being associated with said search word;
receiving a search request from a searcher, said search request including said search word;
identifying said search listing with said search word in response to said search request, thereby arranging said search listing;
measuring the number of actual clicks with respect to said search listing; and
adjusting said information on the reserve fund associated with said advertiser based upon said measured number of actual clicks.

2. The method of claim 1, wherein said step of generating information on the maximum number of expected clicks comprises the steps of:
generating statistical information with respect to the number of clicks during a predetermined previous period;
generating information on the number of expected clicks, based on said statistical information, wherein said information on the number of expected clicks is computed on the basis of regression; and
adding up said number of expected clicks with respect to said predetermined advertising period, thereby generating information on the maximum number of expected clicks.

3. The method of claim 2, wherein said step of generating information on the number of expected clicks comprises the steps of:
setting the number of expected clicks (Y′) by said regression, as Y′=b*mˆX or Y′=m·X+b, wherein X is date; and
determining m and b, variable factors of said regression, by using said statistical information.

4. The method of claim 3, wherein said number of expected clicks (Y′) is set by further considering information on the number of impressions during a particular period or information on the number of season-oriented clicks.

5. The method of claim 4, the method further comprising the step of setting said number of expected clicks (Y′) as Y′=(b*(m1ˆX1)*(m2ˆX2)* . . . (mnˆXn)) or Y′=(m1·X1)+(m2·X2)+ . . . (mn·Xn)+b;
wherein said X1, X2, . . . is input of time series data of said information of the number of impressions or said information on the number of season-oriented clicks.

6. The method of claim 1, wherein said step of measuring said searcher's clicks with respect to said arranged search listing further includes the step of determining a valid click, wherein said step of determining the valid click comprises the steps of:
receiving a click with respect to said search listing from said searcher;
obtaining a first site identifier corresponding to said clicked search listing;
in case that said first site identifier is identical to a second site identifier associated with other click within the predetermined time, determining that said click is invalid; and
determining that the number of clicks except said click which is determined to be invalid is valid.

7. The method of claim 6, wherein said step of determining a valid click is performed every determined period during said advertising period.

8. The method of claim 6, wherein, in case that a request for cancellation of an advertisement is received from said advertiser within said advertising period, said step of determining a valid click is performed just before cancellation.

9. The method of claim 2, wherein said step of transmitting said information on a reserve fund to an advertiser further considers predetermined weight, based on said statistical information.

10. The method of claim 1, comprising the steps of:
transmitting information on a dummy amount to an account associated with said advertiser;
receiving number data corresponding to said information on a dummy amount, from said advertiser; and
determining whether said dummy amount is identical to said number data.

11. The method of claim 1, wherein said step of adjusting said information on the reserve fund includes the step of comparing said actual number of measured clicks with said maximum number of expected clicks; and
in case that said actual number of measured clicks is below said maximum number of expected clicks at the result, the method further includes the steps of generating refund information, and transmitting the same to said advertiser.

12. The method of claim 1, wherein said step of adjusting said information on the reserve find includes the step of comparing said number of measured clicks with said maximum number of expected clicks; and
in case that said number of measured clicks exceeds said maximum number of expected clicks at the result, the method further includes the step of stopping adjustment of said information on the reserve fund.

13. The method of claim 12, the method further comprising the step of generating information on the second maximum number of expected clicks with respect to a second advertising period;
wherein said information on the second maximum number of expected clicks is revised upwards based upon said measured number of actual clicks which exceeds said maximum number of expected clicks.

14. The method of claim 1, comprising the steps of:
generating information on trend of clicks based on said measured number of actual clicks within said advertising period;
generating predicted information on a free advertising period, based on said information trend of clicks; and
transmitting said predicted information on a free advertising period, to said advertiser.

15. The method of claim 14, wherein in case that said adjusted information on the reserve fund is below a predetermined value, said predicted information on a free advertising period is generated.

16. The method of claim 1, the method further comprising the steps of:
maintaining a present information database for recording information on the present state of a predetermined advertisement; and
providing said advertiser with said information on the present state of an advertisement;
wherein said information on the present state of an advertisement includes at least one selected from a group consisting of return on investment (ROI), unique visitor (UV), click through rate (CTR), the number of clicks and the number of impression associated with said search listing during said advertising period.

17. The method of claim 1, wherein said unit click cost is set by satisfying the steps of:
receiving information on a price based on the arranged location of said search listing, from at least one advertiser; and
selling information on one bid price satisfying a predetermined condition, among said received information on the bid price, to each of arranged locations of said search listing by said unit click cost.

18. A method for generating a search result list in response to a searcher's search request and providing a search word advertisement, the method comprising the steps of:
generating information on the maximum number of expected clicks for a predetermined advertising period, in association with a predetermined search word;
receiving information on a bid price with respect to a unit click cost associated with said search word, from at least one advertiser;
determining a unit click cost and an advertiser based on said received information on the bid price;
generating information on a reserve fund using said information on the maximum number of expected clicks and said determined unit click cost;
transmitting said information on the reserve fund to said determined advertiser;
maintaining a search listing associated with said advertiser in association with said search word in a database;
receiving a search request from a searcher, said search request including said search word;
identifying said search listing with said search word in response to said search request, thereby arranging said search listing;
measuring and maintaining information on the number of clicks with respect to said arranged search listing during said advertising period; and
generating refund information or information on a free advertising period, based on said information on the number of clicks and said information on the maximum number of expected clicks.

19. A computer readable record medium recording a program for implementing a method for generating a search result list in response to a searcher's search request and providing a search word advertisement, the method comprising the steps of:
generating information on the maximum number of expected clicks with respect to a predetermined advertising period, in association with a predetermined search word;
generating information on a reserve fund by considering said information on the maximum number of expected clicks and a unit click cost associated with the keyword, thereby transmitting said information on a reserve fund to an advertiser;
receiving confirmative information on receipt of money with respect to said information on a reserve fund from an account associated with said advertiser;
as the step of maintaining a search information database including search listing associated with said advertiser, in response to receipt of said confirmative information on receipt of money, associating at least one said search listing with the search word;
receiving a search request from a searcher;
in response to said search request, identifying search listing associated with said search word, thereby arranging said identified search listing;
measuring the number of clicks with respect to said arranged search listing; and
in correspondence with said measured number of clicks, subtracting said information on a reserve fund.

20. A system for providing a search word advertisement, the system comprising:
a search information database for storing at least one search listing associated with an advertiser, said search information database associating said search listing with at lease one search word;
a search engine for abstracting search listings from a database, the search engine providing a searcher with at least one abstracted search listing upon search request of said searcher by predetermined arrangement method;
a click predicting means for computing information on the maximum number of expected clicks during a predetermined advertising period with respect to said abstracted search listing;
a cost computing means for generating information on a reserve fund by considering said computed information on the maximum number of expected clicks and a unit click cost associated with said search word;
a settlement control means for transmitting said generated information on a reserve fund to an advertiser associated with said search listing and receiving confirmative information on receipt of money with respect to said information on a reserve fund from an account associated with said advertiser; and
an advertisement cost subtracting means for measuring said searcher's number of valid clicks that generate during said advertising period, and subtracting said information on a reserve fund in correspondence with said number of valid clicks;
wherein said click predicting means computes the number of expected clicks on the basis of statistical information with respect to the number of clicks during the predetermined previous period and adds up said computed number of expected clicks with respect to said advertising period, thereby generating information on the maximum number of expected clicks.
